(19) United States
(12) Patent Application Publication
(10) Pub. No.: US 2026/0323470 A1
(43) Pub. Date: Oct. 15, 2026

(54) URSP END USER CONSENT

(71) Applicant: Telefonaktiebolaget LM Ericsson (publ), Stockholm (SE)

(72) Inventors: Lasse Olsson, Träslövsläge (SE); Thorsten Lohmar, Aachen (DE); Elisabeth Mueller, Mainz (DE); Malgorzata Svensson, Nättraby (SE); Jan Lemark, Stockholm (SE)

(21) Appl. No.: 19/483,375

(22) PCT Filed: May 15, 2023
(86) PCT No.: PCT/EP2023/062926

§ 371 Date: Nov. 11, 2025

(51) Int. Cl. H04W 40/02

(52) U.S. Cl. CPC H04W 40/02

(57) ABSTRACT

A method for obtaining consent to configure a new User Equipment (UE) Route Selection Policy (URSP) rule, as well as providing notifications when a new URSP rule is configured. A core network node such as a Policy Control Function (PCF) of a core network can determine that subscriber consent is required before configuring a new URSP rule for a UE associated with the subscriber. Then, the method can include provide an indication of the new URSP rule to the subscriber and in response to receiving an acceptance indication, configuring the UE with the new URSP rule.

### TECHNICAL FIELD

The present disclosure relates to a method for obtaining consent and providing notifications for new User Equipment (UE) Route Selection Policy (URSP) rules in a wireless communications network.

### BACKGROUND

Service specific parameter provisioning describe the procedures for enabling an Application Function (AF) to provide service specific parameters, such as User Equipment (UE) Route Selection Policy (URSP) rules to Fifth Generation (5G) system (5GS) via a core network.

Today, all consumer smartphones are configured with only a single Protocol Data Unit (PDU) Session (there are more, e.g., for Internet Protocol (IP) Multimedia Subsystem (IMS), but these PDU Sessions are not visible or usable for normal applications). With 5G Core Network specifications in Third Generation Partnership Project (3GPP) Release 15, the technical concept of Network Slicing was introduced. With the introduction of Network Slicing, there was a feature that support multiple PDU Sessions on the device side that was introduced.

An enterprise or a consumer should be able to activate and use additional PDU Sessions, beside the default mobile broadband (MBB_PDU Session. For easier management and to provide the device (UE) with policies for PDU Session Selection, the “UE Route Selection Policy” (URSP) was introduced. The URSP rules contain a “Traffic Descriptor” Section, providing the UE with information about the traffic type, which should be connected to the PDU Session, described by the URSP rule. The Traffic Descriptor can be an Application Descriptor, an IP Descriptor, a Domain Descriptor, a Traffic Category, Connection Capability or some other descriptor. The URSP rule contain also additional conditions about the PDU Session, e.g., the Session and Service Continuity (SSC) Mode, some Time Window during which the PDU Session can be activated or some location criteria, when the PDU Session is geo-fenced. The URSP, UE Route Selection Policy, is in the core network logically realized by a new PDU Session which in turn is connected to certain quality of service characteristics and charging details.

With Android 12, the support for Network Slicing and for URSP rules has been introduced into Android Operating System. With Android 12, only a single PDU Session can be established. With Android 13, Android supports more simultaneous active PDU Sessions. One prime use-case is for Fully Managed Devices, i.e., an Enterprise IT admin defines a set of device policies to be used, when accessing Enterprise specific services.

Several different network entities can trigger a URSP update in the UE, this procedure is described in Technical Specification (TS) 23.503, v18.1.0, chapter 6.6.2.2, Configuration and Provision of URSP as follows:

The UE (device) may be provisioned (signalled) with URSP rules by a Policy Control Function (PCF_of the Home Public Land Mobile Network (HPLMN)). When the UE is roaming, the PCF in the HPLMN may update the URSP rule in the UE. For URSP rules, the UE shall support the provisioning (signalling) from the PCF in the HPLMN. In addition, the UE may also be pre-configured with URSP rules (e.g., by the operator).

Only the URSP rules provisioned (signalled) by the PCF are used by the UE, if both URSP rules provisioned (signalled) by the PCF and pre-configured URSP rules are present. If no URSP rule is provisioned (signalled) by the PCF, and the UE has pre-configured rules configured in both the Universal Subscriber Identity Module (USIM) and Mobile Equipment (ME), then only the pre-configured URSP rules configured in the USIM is used.

If the PCF receives application guidance for URSP determination that may apply to a given UE from a Unified Data Repository (UDR) as specified in clause 4.15.6.7 of TS 23.502, v18.1.1, the PCF may verify the requested parameters (which are described in clause 4.15.6.10 of TS 23.502) with regards to the existing URSP rules and compose the URSP rules for the UE as described in clause 6.2.4 of TS 23.548, v18.1.1.

As described in Chapter 4.15.6.10, Application guidance for URSP determination of TS 23.502, at least 3 different signaling procedures are involved in the URSP provisioning.

This clause describes the procedures to allow an AF to provide guidance for URSP determination to 5G system via a Network Exposure Function (NEF). The AF may belong to the operator or to an external party. The PCF considered in this clause is in the Home PLMN as it is the PCF that determines the URSP for the UE.

NEF may, based on local configuration, complement missing service parameters. Additionally, based on operator's local policy, NEF may request for service specific authorization for the service parameters for an individual UE (e.g., to authorize the Corporate or MTC provider represented by the AF and the requested DNN, S-NSSAI for the related UE) before storing the service parameters into the UDR via Nnef_ServiceParameter_Create operation.

FIG. 1 is a message sequence chart for application guidance for User Equipment (UE) Route Selection Policy (URSP) according to some embodiments of the present disclosure and shows the enhanced procedure as defined in clause 4.15.6.7a of TS 23.502 between the UE 102, a Radio Access Network (RAN) 104, an Access and Mobility Management Function (AMF) 106, PCF 108, Unified Data Manager (110), UDR 112, NEF 114, and AF 116.

Chapter 4.15.6.7, Service specific parameter provisioning:

The AF 116 may issue requests on behalf of applications not owned by the PLMN serving the UE 102. The AF request sent to the NEF 114 contains the information as below:
1) Service Description: Service Description is the information to identify a service the Service Parameters are applied to. The Service Description in the AF request can be represented by the combination of Data Network Name (DNN) and Single Network Slice Selection Assistance (S-NSSAI), an AF-Service-Identifier or an External Application Identifier.
2) Service Parameters: Service Parameters are the service specific information which needs to be provisioned in the Network and delivered to the UE 102 in order to support the service identified by the Service Description.
3) Target UEs or a group of UEs: Target UE(s) or a group of UEs indicate the UE(s) who the Service Parameters shall be delivered to. Individual UEs can be identified by a Generic Public Subscription Identifier (GPSI), or an IP address/Prefix or a Medium Access Control (MAC) address. Groups of UEs can be identified by an External Group Identifiers as defined in TS 23.682, v18.0.0. If identifiers of target UE(s) or a group of UEs are not provided, then the Service Parameters shall be delivered to any UEs using the service identified by the Service Description.
4) Subscription to events: The AF 116 may subscribe to notifications about the outcome of the UE Policies delivery due to service specific parameter provisioning.

FIG. 2 is a message sequence chart for service specific parameter provisioning according to some embodiments of the present disclosure.

FIG. 3 is a message sequence chart for a User Equipment (UE) configuration update procedure for transparent UE policy according to some embodiments of the present disclosure.

Chapter 4.2.4.3 UE Configuration Update procedure for transparent UE Policy delivery: This procedure is initiated when the PCF 108 wants to update UE policy information (i.e., UE policy) in the UE configuration.

FIG. 4 is a message sequence chart that merges the message sequence charts of FIGS. 1-3 according to some embodiments of the present disclosure, and the steps below are with reference to FIG. 4.

402. UE Registers to the 5GC and, AMF registers the UE 102 in UDM 110 and establishes a UE Policy Association towards the PCF 108. Both UDM 110 and PCF 108 start to subscribe on subscription/policy changes in the UDR 112.

404. To create a new request, the AF 116 invokes an Nnef_ServiceParameter_Create service operation. The request may include subscription information to the report of the outcome of UE Policy delivery.

406. The AF 116 sends its request to the NEF 114. The NEF 114 authorizes the AF request. The NEF 114 performs the following mappings:
Map the AF-Service-Identifier into DNN and S-NSSAI combination, determined by local configuration.
Map the External Application Identifier into the corresponding Application Identifier known in the core network.
Map the GPSI in Target UE Identifier into Subscription Permanent Identifier (SUPI), according to information received from UDM 110.
Map the External Group Identifier in Target UE Identifier into Internal Group Identifier, according to information received from UDM 110.

If the AF 116 subscribed to the outcome of UE Policy delivery, the AF 116 indicates where the AF 116 receives the corresponding notifications.

(In the case of Nnef_ServiceParameter_Create): The NEF 114 assigns a Transaction Reference ID to the Nnef_ServiceParameter_Create request.

408. The NEF 114 sends Nudm_Service SpecificAuthorisation_Create Request including S-NSSAI/DNN and service type received from AF 116.

410. If the request is for an individual UE 102, the UDM 110 checks at the list of subscribed/allowed S-NSSAI/DNNs for the UE and other service info (e.g., MTC provider is authorized for the UE).

412. The UDM 110 responds to the NEF with the service authorization result. If authorization fails (e.g. DNN is not subscribed for the UE or it is different from the group related data, UE subscription or group related data does not allow to modify URSP rules dynamically by an AF 116 or by such specific AF or MTC provider), UDM 110 returns a negative response with an appropriate error code and the NEF rejects the request with the proper error code to inform the AF about the request not authorized.

414. (in the case of Nnef_ServiceParameter_Create or Update): The NEF 114 stores the AF request information in the UDR as the “Application Data” (Data Subset setting to “Service specific information”) together with the assigned Transaction Reference ID.

416. The NEF 114 responds to the AF 116. In the case of Nnef_ServiceParameter_Create response message, the response message includes the assigned Transaction Reference ID.

If the UE 102 is registered to the network and the PCF performs the subscription to notification to the data modified in the UDR by invoking Nudr_DM_Subscribe (AF service parameter provisioning information, SUPI, Data Set setting to “Application Data”, Data Subset setting to “Service specific information”) at step 0, the following steps are performed:

418. The PCF(s) 108 receive(s) a Nudr_DM_Notify notification of data change from the UDR 112.

420. PCF 108 invokes Namf_Communication_N1N2Message Transfer service operation provided by the AMF 106. The message includes SUPI, UE Policy Container.

422. If the UE 102 is registered and reachable by AMF 106 in either 3GPP access or non-3GPP access, AMF 106 shall transfer transparently the UE Policy container to the UE via the registered and reachable access.

If the UE 102 is registered in both 3GPP and non-3GPP accesses and reachable on both access and served by the same AMF, the AMF 106 transfers transparently the UE Policy container to the UE via one of the accesses based on the AMF local policy.

If the UE is not reachable by AMF 106 over both 3GPP access and non-3GPP access, the AMF 106 reports to the PCF 108 that the UE Policy container could not be delivered to the UE using Namf_Communication_N1N2TransferFailureNotification.

If AMF 106 decides to transfer transparently the UE Policy container to the UE via 3GPP access, e.g. the UE is registered and reachable by AMF in 3GPP access only, or if the UE is registered and reachable by AMF 106 in both 3GPP and non-3GPP accesses served by the same AMF and the AMF 106 decides to transfer transparently the UE Policy container to the UE via 3GPP access based on local policy and the UE 102 is in CM-IDLE and reachable by AMF 106 in 3GPP access, the AMF 106 starts the paging procedure by sending a Paging message described in the step 4b of Network Triggered Service Request (in clause 4.2.3.3). Upon reception of paging request, the UE 102 shall initiate the UE Triggered Service Request procedure (clause 4.2.3.2).

424. If the UE 102 is in CM-CONNECTED over 3GPP access or non-3GPP access, the AMF 106 transfers transparently the UE Policy container (UE policy information) received from the PCF 108 to the UE 102. The UE Policy container includes the list of Policy Sections as described in TS 23.503.

426. The UE 102 updates the UE policy provided by the PCF 108 and sends the result to the AMF 106.

428. The AMF 106 forwards the response of the UE 102 to the PCF 108 using Namf_Communication_N1MessageNotify.

430. If the AF 116 subscribed to notifications about the outcome of UE Policies delivery due to Service specific parameter provisioning targeting a single UE and the PCF 108 is notified of UE Policy Container from the AMF, the PCF 108 notifies the UE Policy delivery result contained in the UE Policy container as the outcome of the procedure to NEF 114 by sending Npcf_EventExposure_Notify.

If PCF 108 is notified about UE Policy delivery failure from the AMF 106 due to UE not reachable, the PCF 108 may determine to retry step 6 of this procedure when the UE becomes reachable. In such a case, the PCF 108 may report the interim status i.e., UE 102 is temporarily unreachable as the outcome of the procedure to NEF by sending Npcf_EventExposoure_Notify.

If the PCF 108 determines the failure of the UE Policies delivery procedure, the PCF 108 notifies the failure with an appropriate cause such as UE 102 is unreachable as the outcome of the procedure to NEF 114 by sending Npcf_EventExposure_Notify.

432. When the NEF 114 receives Npcf_EventExposure_Notify, the NEF 114 performs information mapping (e.g., AF Transaction Internal ID provided in Notification Correlation ID to AF Transaction ID, SUPI to GPSI, etc.) and triggers the appropriate Nnef_ServiceParameter_Notify message.

Step 2 details are described in 3GPP TS 29.522, v18.1.0, chapter 4.4.20, Procedures for service specific parameter provisioning:

These procedures are used by an AF to provide service specific parameters to the 5G system via the NEF. In order to provision service specific parameters to the 5G system, the AF shall send an HTTP POST message to the NEF targeting the resource “Service Parameter Subscriptions”, the HTTP POST message shall include the ServiceParameterData data structure as request body. The ServiceParameterData data structure shall include:
service description via:
   a) a combination of DNN and S-NSSAI within the “dnn” attribute and the “snssai” attribute respectively;
   b) an AF service identifier within the “afServiceId” attribute; or
   c) an application identifier within the “appId” attribute;
   NOTE: When the feature “AfGuideURSP” is supported, only the “afServiceId” attribute needs to be included for providing guidance for URSP determination.
indication of the UEs to which the subscription applies via:
   a) identification of an individual UE within the “gpsi” attribute;
   b) an IPV4 address of the UE within the “uelpv4” attribute;
   c) an IPV6 address of the UE within the “uelpv6” attribute;
   d) a MAC address of the UE within the “ueMac” attribute;
   e) an identification of a group of UE(s) within the “exterGroupld” attribute; or
   f) an identification of any UE within the “anyUelnd” attribute.
service parameters for at least one of the following:
If the “AfGuideURSP” feature is supported, URSP service parameters via contents for the AF guidance on URSP within the “urspGuidance” attribute, which shall include one or more URSP rule requests. Each URSP rule request may include a traffic descriptor within the “trafficDesc” attribute and one or more route selection parameter sets within the “routeSelParamSets” attribute. Each route selection parameter set may include a precedence value within the “precedence” attribute, a DNN within the “dnn” attribute, an S-NSSAI within the “snssai” attribute, and a spatial validity condition within the “spatialValidity” attribute. If the request contains only one route selection parameter set, each of the optional attributes “dnn”, “snssai”, “precedence”, and “spatialValidity” that is missing from the request may be complemented by the NEF based on local configuration for the provided AF service identifier. It is up to the NEF to transform the information of the “spatialValidity” attribute into a list of TAIs.

and may include:
If the “AfNotifications” feature is supported,
   a) subscription to event notification of the outcome related to invocation of service parameter provisioning within the “subNotifEvents” attribute; and
   b) notification URI within the “notificationDestination” attribute.

One of the problems is that the URSP updated, e.g., received by the AF 116, step 424 in the merged flow above might not be what the device user actually wants but there exist no way for the device user to decline, nor to explicitly consent.

Additionally, it's not possible from the UE 102 to remove any installed URSP. Currently, the 3GPP specification does not mention any UE side acceptance steps during the URSP rule. It seems to be assumed that the Operating System is always installing and using new URSP rules. However, the device user or the subscription owner may not always agree with the installation & usage of a new URSP rule, thus a consent request step is missing in the specifications.

Another problem with existing technology (3GPP specifications) is the miss-use protection: The device user uses an enterprise subscription (the user device is equipped with a SIM, where connectivity cost of the employee are covered by the employer) When a device user installs a gaming related URSP rule on the enterprise subscription, the enterprise should have the possibility to reject the installation of the gaming related URSP. The device user (employee) is likely accepting the installation, while the subscription owner (employer) would reject it.

### SUMMARY

Various embodiments disclosed herein provide for a method for obtaining consent to configure a new User Equipment (UE) Route Selection Policy (URSP) rule, as well as providing notifications when a new URSP rule is configured. A core network node of a core network can determine that subscriber consent is required before configuring a new URSP rule for a UE associated with the subscriber. Then, the method can include providing an indication of the new URSP rule to the subscriber and in response to receiving an acceptance indication, provisioning (or configuring) the UE with the new URSP rule.

In an embodiment, the subscriber is an enterprise account, and providing the indication of the new URSP rule to the subscriber comprises providing the indication of the new URSP rule to a server associated with the enterprise account.

In an embodiment, the method includes providing a notification to the UE on which the new URSP rule is configured.

In an embodiment, the providing the notification is based on location information associated with at least one of a subscriber account or the UE associated with the subscriber.

In an embodiment, the providing the indication of the new URSP rule to the subscriber comprises providing the indication to the UE associated with the subscriber.

In an embodiment, the providing the indication of the new URSP rule to the subscriber comprises providing the indication to another UE associated with the subscriber.

In an embodiment, the method can include setting a flag in subscription data associated with the subscriber that identifies the acceptance indication.

In an embodiment, the determining that subscriber consent is required includes providing the new URSP rule and subscriber information to a Unified Data Management (UDM) function and receiving an indication of subscriber consent requirement from the UDM function.

In an embodiment, the indication of subscriber consent requirement further comprises a callback Uniform Resource Locator (URL).

In an embodiment, the providing the indication of the new URSP rule to the subscriber comprises providing the callback URL to the subscriber.

In an embodiment, the method includes, in response to receiving a declination indication, setting a flag in subscription data associated with the subscriber that identifies the declination indication.

In an embodiment, a core network node is provided that is configured for obtaining consent from a subscriber about configuring a new URSP rule. The core network node can include processing circuitry that determines that subscriber consent is required before configuring the new URSP rule for a UE associated with the subscriber. The processing circuitry can also provide an indication of the new URSP rule to the subscriber. The processing circuitry can also, in response to receiving an indication of consent, provision the UE with the new URSP rule.

In an embodiment, a method can be performed by a UE for responding to a request for consent about configuring a new URSP rule. The method can include receiving from a core network node an indication of the new URSP rule comprises information about at least one of: charging and quality of service characteristics of the new URSP rule. The method can also include displaying the indication of the new URSP rule on the UE. According to embodiments, the method may comprise the UE receiving said indication of the new URSP rule comprises information from a PCF (i.e. the PCF transmits said message towards the UE), wherein the indication is sent via an AMF. According to other embodiments, where local AMF solutions are implemented, said message may be transmitted by an AMF towards the UE.

In an embodiment, the method can include providing at least one of an acceptance of the new URSP rule or a declination of the new URSP rule to a core network node.

In an embodiment, the method can include providing at least one of an acceptance of the new URSP rule or a declination of the new URSP rule via a callback URL that was associated with the indication of the new URSP rule.

In an embodiment, a UE can be configured for responding to a request for consent about configuring a new URSP rule. The UE can include a radio and processing circuitry configured to receive, from a core network node, an indication of a new URSP rule, wherein the indication of the new URSP rule comprises information about charging and quality of service characteristics of the new URSP rule. The processing circuitry can also display the indication of the new URSP rule on the UE.

Some of the advantage provided by the method disclosed in the present disclosure is that the end user (device user and/or subscription owner) is up to date regarding the rules that exist on the UE, and has given his/her consent to actually use them. Additionally, there is no or little risk for QoE degrading experiences like e.g., bill shock or over-charging. Specifically, when adding enterprise-paid PDU Sessions to a privately owned network subscription or when allowing private usages of enterprise devices, there is an increased need to control the installation and usage of new URSP rules (URSP rules are used for PDU Session Selection and each PDU Session may be associated with different charging rules).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a message sequence chart for application guidance for User Equipment (UE) Route Selection Policy (URSP) according to some embodiments of the present disclosure;

FIG. 2 is a message sequence chart for service specific parameter provisioning according to some embodiments of the present disclosure;

FIG. 3 is a message sequence chart for a UE configuration update procedure for transparent UE policy according to some embodiments of the present disclosure;

FIG. 4 is a message sequence chart that merges the message sequence charts of FIGS. 1-3 according to some embodiments of the present disclosure;

FIG. 5 is a message sequence chart for obtaining consent to configure a new URSP rule according to some embodiments of the present disclosure;

FIG. 6 is another message sequence chart for obtaining consent to configure a new URSP rule according to some embodiments of the present disclosure;

FIG. 7 is a message sequence chart where a UE requests UE policy management procedure according to some embodiments of the present disclosure;

FIG. 8 illustrates one example of a cellular communications system according to some embodiments of the present disclosure;

FIGS. 9 and 10 illustrate example embodiments in which the cellular communication system of FIG. 8 is a Fifth Generation (5G) System (5GS);

FIG. 11 is a schematic block diagram of a radio access node according to some embodiments of the present disclosure;

FIG. 12 is a schematic block diagram that illustrates a virtualized embodiment of the radio access node of FIG. 11 according to some embodiments of the present disclosure;

FIG. 13 is a schematic block diagram of the radio access node of FIG. 11 according to some other embodiments of the present disclosure;

FIG. 14 is a schematic block diagram of a UE according to some embodiments of the present disclosure; and

FIG. 15 is a schematic block diagram of the UE of FIG. 14 according to some other embodiments of the present disclosure.

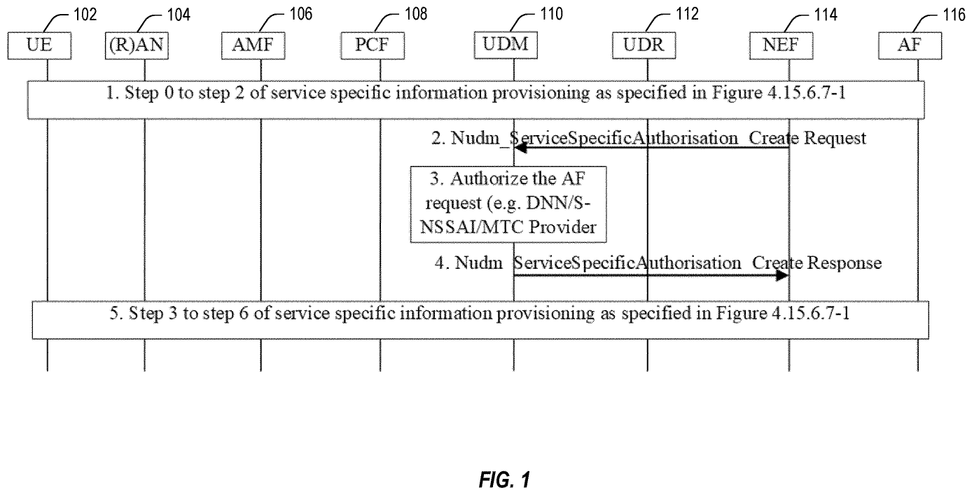

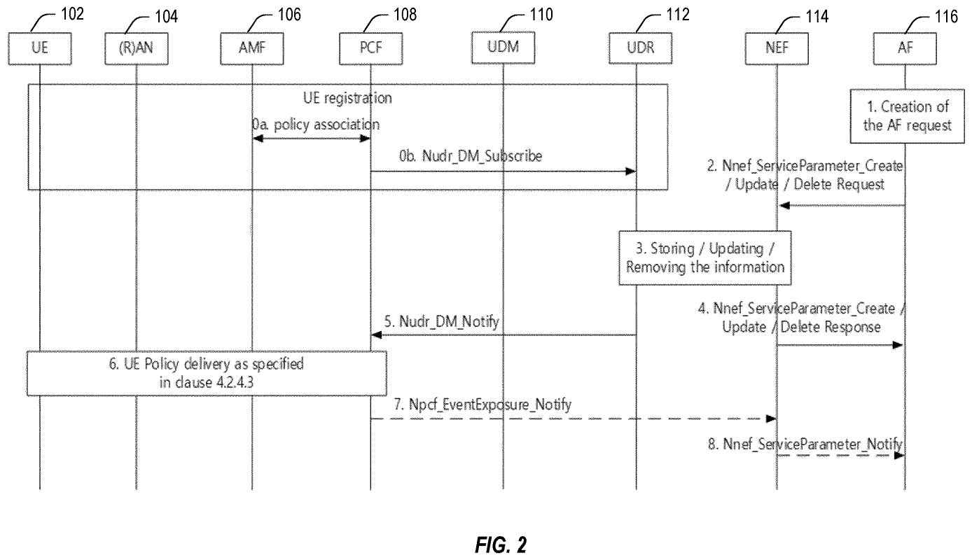

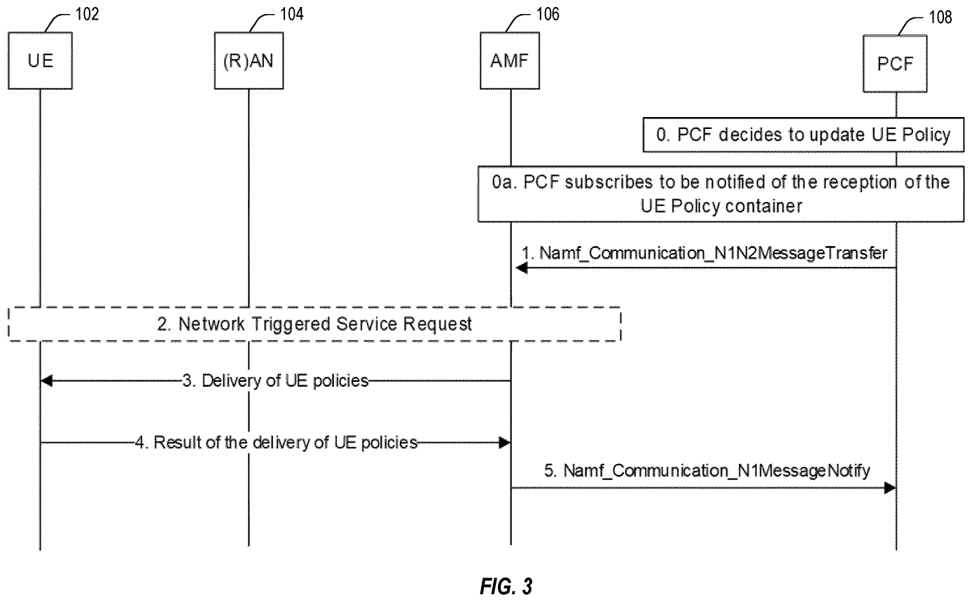

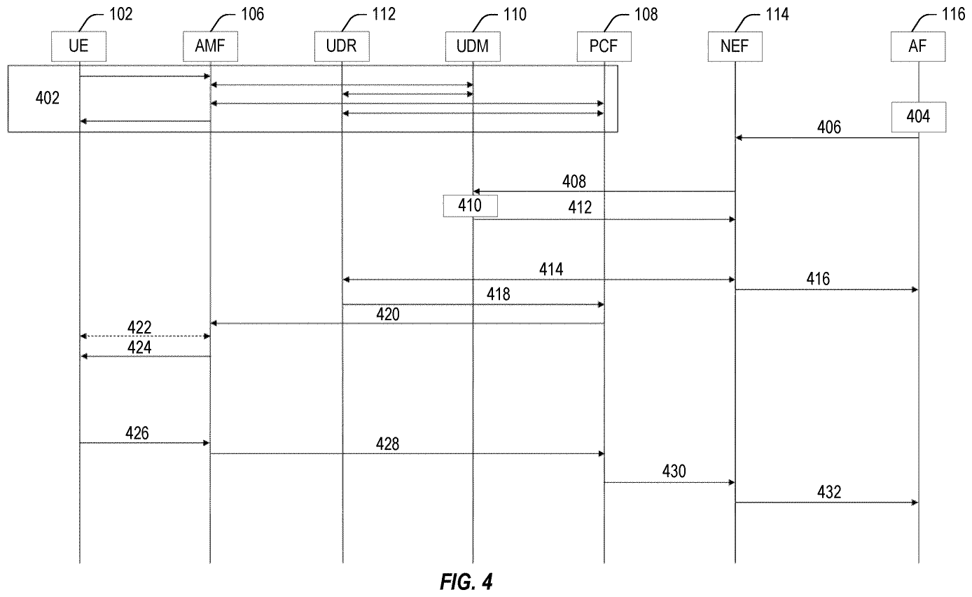

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU) or a network node that implements part of the functionality of some other type of radio access node.

Core Network Node: As used herein, a “core network node” is any type of node in a core network or any node that implements a core network function.. Some examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure relates to a solution to the above described problems in which a user behind the UE can be provided with notifications or option to consent or approve changes when a new User Equipment (UE) Route Selection Policy (URSP) rule is provisioned by the network and that the user shall have the option to decline the offer. This shall include usability handling and potentially a communications service provider (CSP) owned Application solution where the App Client is installed in the UE/Device. The present disclosure specifically addresses a situation where the device user/connectivity subscription owner should get an opportunity to consent to new URSP rules provisioned by the network to the UE.

For example, when an improved but more expensive connectivity is available e.g., for Gaming Applications, and a new URSP is provisioned the user may want to get notifications and select to keep the present one, to avoid unwanted cost or activate/accept the new one which gives a better gaming experience but also a higher cost.

The following cases are considered:

The device subscription may be owned by an individual user (e.g., a consumer) and the individual user or typically the device user.

The device subscription may be owned by an enterprise (or IOT company) and the enterprise customer should be able to accept/reject, whether a given URSP rule is installed on a device or for a certain enterprise subscription. In the case where the enterprise customer is providing the approval to configure the UE with the new URSP rule, the user of the UE, such as the employee of the enterprise, can still be informed about the new URSP rule. In some situations, the notifications to the end user can be optional, and in other situations, depending on privacy rules applicable to the end user or UE, and the type of URSP rule, the notification can be mandatory.

The device subscription may belong to a family subscription, and a subscriber with authority to make changes to the account, (e.g., a parent) can provide the consent to the installation of new URSP rules on each device.

The end user (current device user and/or subscription owner) shall have the possibility to accept/decline the installation of a new URSP rule on a device.

The subscription owner, if different compared to the user, shall have the possibility to accept/decline a new URSP rule.

The subscription owner and/or user can also be provided with the option to remove unwanted URSP rule(s). The present disclosure provides new signaling procedures to introduce the ability to manage consent requests from the device user and/or the subscription owner.

The network subscription should contain a flag, that the given subscription is used by a different user than the subscription owner. For example, the subscription is an enterprise subscription or belong to a family subscription. When this flag is set, then the network subscription entry in the UDR should contain some consent request information, e.g., an email address or a callback Uniform Resource Locator (URL). The 5G System is then executing a consent request procedure before installing a new URSP rule.

The PCF may add a new flag into the UE Policy container, that no additional consent is needed / desired. When the Application Function (AF) is given consent, the device user should NOT be bothered/should not have the possibility to decline.

The 5G System can request consent from different entities, depending on the nature of the URSP rule and the subscription (International Mobile Subscriber Identify (IMSI)/Subscription Permanent Identifier (SUPI)) ownership. The Network Subscription entry is extended to keep according information.

When the subscription owner is an individual and the device user, then the device user gets a notification, thus more insights when a new URSP is provisioned. The device user gets information of the currently provisioned URSP, e.g., gaming characteristics and/or cost. The device user gets the option (on the UE/SmartPhone) to accept/decline the new URSP. The App/device user shall have the possibility to manually remove an unwanted URSP, from the UE and in the network (i.e., UDR, PCF).

When the subscription owner is an enterprise customer (or an Internet of Things (IOT) customer), then the subscription owner is requested to accept the installation of the new URSP rule. This can be either for a specific device (e.g., identified by International Mobile Equipment Identity (IMEI) or for a specific subscription (e.g., identified by an IMSI). The consent request may include an identifier of the AF, which is requesting the URSP rule installation. When the subscription belongs to a family subscription, then one or more “subscription manager” (or subscription parent) are identified, who shall give content for some child subscriptions.

The consent request can be realized by a graphical user interface (GUI) interaction on the same device, to which the URSP rule is installed.

The consent request can also be realized in the form of a web-hook or a web callback function, using the service back architecture principles. Alternatively, the consent request can be realized by an email, which is sent to a subscription responsible.

The UDM/UDR is extended to contain consent related information, specifically, whether consent from an external user is required before URSP rule installation. This may be realized by a flag. When multiple URSP rules are distributed, which consent related information may be associated with each URSP rule.

Some of the advantage provided by the method disclosed in the present disclosure is that the end user (device user and/or subscription owner) is up to date regarding the rules that exist on the UE and has given his/her consent to actually use them. Additionally, there is no or little risk for QoE degrading experiences like e.g., bill shock or over-charging. Specifically, when adding enterprise-paid PDU Sessions to a privately owned network subscription or when allowing private usages of enterprise devices, there is an increased need to control the installation and usage of new URSP rules (URSP rules are used for PDU Session Selection and each PDU Session may be associated with different charging rules). In an embodiment in which the UE is an augmented reality/virtual reality (AR/VR) device, an advantage can be realized by the end user in being able to reject URSP rules that may lower the quality of experience (QoE), depending on how the AR/VR device is being used at that time. The user may want improved ability to control the QoE while balancing performance against costs, fees, etc., depending on how the device is being used, and the methods disclosed herein provide a mechanism for that control.

At a high level, there are three major embodiments or features of the present disclosure that completement each other. First, the subscription owner can be notified that a new URSP is proposed to be provisioned, and the notification can include a request for approval/rejection.

Secondly, a flag can be set in the subscription data that stores the consent details per SUPI and Application so that future URSP rule changes can be streamlined, and either approved automatically, rejected automatically, or sent to the subscriber for approval depending on the feedback.

Next, logic can be added in the UE that makes the end user (current device user) aware that a new URSP is being provisioned, and informed of any charging and quality of service (QOS) characteristics associated with the URSP rule change. The subscriber can reject the procedure step 426 as described above, determined/controlled by the end user (this can also clean up all stored URSP data in PCF/UDR regarding the rejected procedure as stated in 24.501 Annex D. 2.1.2 Network-requested UE policy management procedure initiation.

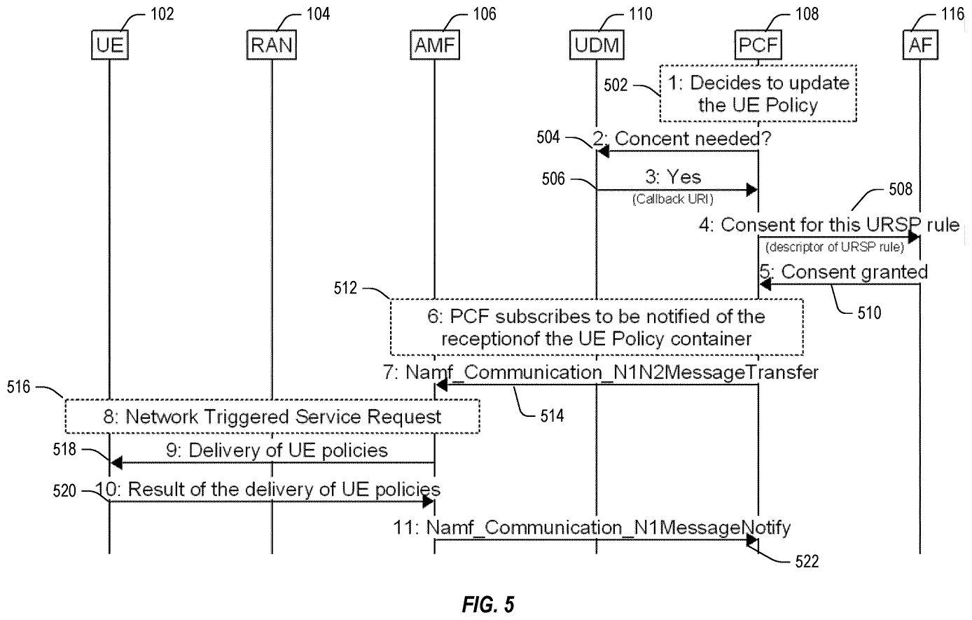

FIG. 5 is a message sequence chart for obtaining consent to configure a new URSP rule according to some embodiments of the present disclosure.

When the subscription owner is not the (current) device user, then the following call flow can apply (example with a callback function). In an embodiment, the subscriber is an enterprise account, and providing the indication of the new URSP rule to the subscriber comprises providing the indication of the new URSP rule to a server associated with the enterprise account.

Step 502. The PCF 108 can decides that a UE policy needs to be updated. The trigger may come from an external AF (a different AF than AF 116 in step 4).

Step 504. The PCF 108 checks with UDM 110, whether it is ok to send the UE Policy update or whether a separate consent is needed. The UE policy descriptor or id may be provided with the request.

Step 506. The UDM 110 confirms, that a dedicated consent grant is needed prior to distribution of the new UE policy. The UDM 110 provides a callback URL for the responsible AF 116.

Step 508. The PCF 108 sends a consent request message to the AF 116 (e.g., the a cloud gaming company) or to an Enterprise Admin organization, providing a UE policy description with the grant request. In case of an external AF (likely for an application provider), the consent grant request may be routed via the NEF 114. The PCF 108 can transmit, or facilitate transmission of the indication of the new URSP rule to the subscriber by either providing the indication to the UE 102 via the RAN 104 or via the AF 116.

In an embodiment, the providing the notification is based on location information associated with at least one of a subscriber account or the UE 102 associated with the subscriber. The location information can be relevant when determining which rules related to privacy, consent, and information related to URSP rules changes are relevant when determining whether to obtain consent or provide notifications.

In an embodiment, the providing the indication of the new URSP rule to the subscriber comprises providing the indication to the UE 102 associated with the subscriber.

In another embodiment, the providing the indication of the new URSP rule to the subscriber comprises providing the indication to another UE associated with the subscriber. In this case, such as when there is a family plan, the UE on which the URSP rule is to be provisioned can be notified, even if the UE did not provide the consent. In other embodiments, a parent UE can be notified when new URSP rules are configured on a child UE.

Step 510. When the AF 116 or the Enterprise Admin organization via the URL grants the consent for the UE policy installation, then the PCF 108 continues with the steps 514, 516, 518, 520, and 522 as standardized in provisioning the UE 102 with the new URSP rule. At step 518, when provisioning the UE 102 with the new URSP rule, the URSP rule associates the traffic of a certain application with e.g., an S-NSSAI and DNN. The new URSP rule enforces the following routing policy: the traffic of an application on the UE 102 is transferred on a PDU Session supporting the specified S-NSSAI and DNN. If this PDU Session is not established, the UE shall attempt to establish a PDU Session with the specified S-NSSAI and DNN.

In an embodiment, the PCF 108, or AMF 106 at step 512 can also cause a flag to be set in subscription data at UDM 110 associated with the subscriber that identifies the acceptance or declination information.

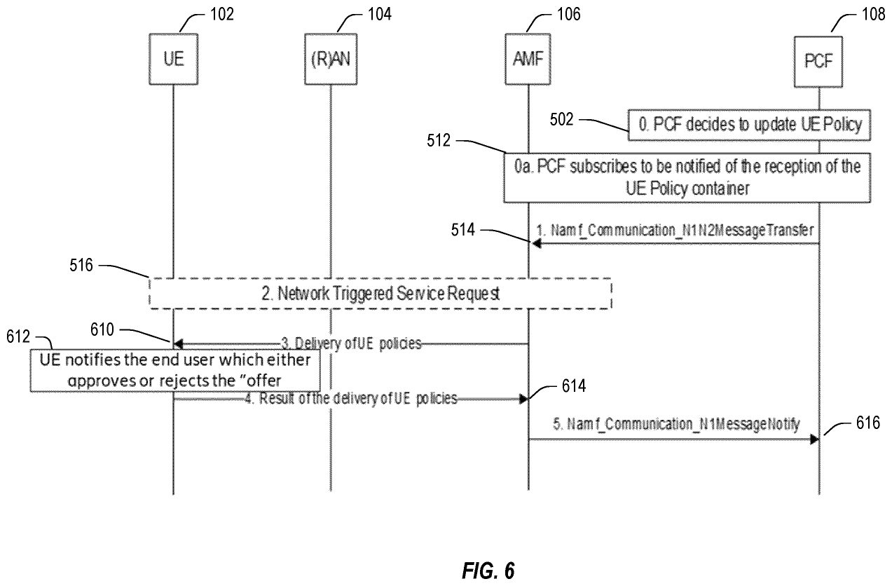

FIG. 6 is a message sequence chart for obtaining consent to configure a new URSP rule according to another embodiments of the present disclosure.

In the message sequence chart in FIG. 6, steps 502, 512, 514, and 516 are shown and are similar to FIG. 5. At 610, the new URSP rule or indication of the rule can be provided from the AMF 106 to the UE 102.

At 612, the new logic in the UE 102 can then notify the end user who has the option to approve or reject the new URSP rule. The UE 102 can in an embodiment display the new URSP and information about the rule such as quality characteristics, charging characteristics, and other information, via a GUI.

After the subscriber or end user makes a selection, the UE 102 can report the result back to the core network via the AMF 106 at step 614. The AMF 106 can then report the result to the PCF 108 at step 616.

If the Network-requested UE policy management procedure not accepted by the UE 102:

If the UE 102 could not execute all instructions included in the UE policy section management list IE successfully, the UE 102 can:
A) set the procedure transaction identity (PTI) information element (IE) to the PTI value received within the MANAGE UE POLICY COMMAND message and encode the UE policy section identifier (UPSI) associated with the instructions which could not be executed successfully and the associated UE policy delivery service cause indicating the cause of the failure in a UE policy section management result IE as specified in subclause D.5.3 and include it in a MANAGE UE POLICY COMMAND REJECT message, and
B) transport the MANAGE UE POLICY COMMAND REJECT message using the NAS transport procedure as specified in subclause 5.4.5.

Upon receipt of the MANAGE UE POLICY COMMAND REJECT message, the PCF shall stop timer T3501. Any instruction that was included in the UE policy section management list IE and whose associated UPSI is not included in a UE policy section management result IE of the received MANAGE UE POLICY COMMAND REJECT message is considered as successfully executed.

The PCF 108 should ensure that the PTI value assigned to this procedure is not released immediately. The way to achieve this is implementation dependent. For example, the PCF 108 can ensure that the PTI value assigned to this procedure is not released during the time equal to or greater than the default value of timer T3501.

Upon receipt of the notification from the AMF that the UE is not reachable, the PCF shall stop the T3501.

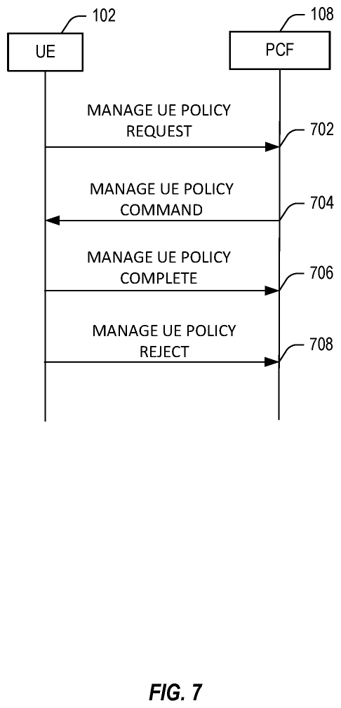

FIG. 7 is a message sequence chart where a UE requests UE policy management procedure according to some embodiments of the present disclosure. If the end user has no possibility to decline the offer a new procedure can be triggered afterwards, by the UE 102, to request removal of the URSP rule.

This new procedure can initiate at step 702 where the UE 102 provides MANAGE UE POLICY REQUEST to a PCF 108 in the core network. The MANAGE UE POLICY REQUEST can include PTI, UPSI (to identify the URSP) and a UE Identifier e.g., SUPI.

This message shall trigger the PCF 108 to send the MANAGE UE POLICY COMMAND at step 704 then follow the already specified flow, see below:

Upon receipt of the MANAGE UE POLICY COMMAND message with a PTI value currently not used by a network-requested UE policy management procedure, for each instruction included in the UE policy section management list IE, the UE 102 shall.
a) store the received UE policy section of the instruction, if the UE 102 has no stored UE policy section associated with the same UPSI as the UPSI associated with the instruction;
b) replace the stored UE policy section with the received UE policy section of the instruction, if the UE 102 has a stored UE policy section associated with the same UPSI as the UPSI associated with the instruction; or
c) delete the stored UE policy section, if the UE 102 has a stored UE policy section associated with the same UPSI as the UPSI associated with the instruction and the UE policy section contents of the instruction is empty.

It can then be beneficial, after step 616 that the URSP rejected OR explicitly removed by the UE is flagged as unwanted in the 5GC (typically in the UDR 112 or UDM 110) so that when the next time an AF 116 tries to activate the exact same URSP towards the same subscriber, then it will be rejected either in Box B or in step 512 in the main flow in FIG. 5 to save signaling.

FIG. 8 illustrates one example of a cellular communications system 800 in which embodiments of the present disclosure may be implemented. In the embodiments described herein, the cellular communications system 800 is 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 802-1 and 802-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 804-1 and 804-2. The base stations 802-1 and 802-2 are generally referred to herein collectively as base stations 802 and individually as base station 802. Likewise, the (macro) cells 804-1 and 804-2 are generally referred to herein collectively as (macro) cells 804 and individually as (macro) cell 804. The RAN may also include a number of low power nodes 806-1 through 806-4 controlling corresponding small cells 808-1 through 808-4. The low power nodes 806-1 through 806-4 can be small base stations (such as pico or femto base stations) or RRHs, or the like. Notably, while not illustrated, one or more of the small cells 808-1 through 808-4 may alternatively be provided by the base stations 802. The low power nodes 806-1 through 806-4 are generally referred to herein collectively as low power nodes 806 and individually as low power node 806. Likewise, the small cells 808-1 through 808-4 are generally referred to herein collectively as small cells 808 and individually as small cell 808. The cellular communications system 800 also includes a core network 810, which in the 5G System (5GS) is referred to as the 5GC. The base stations 802 (and optionally the low power nodes 806) are connected to the core network 810.

The base stations 802 and the low power nodes 806 provide service to wireless communication devices 812-1 through 812-5 in the corresponding cells 804 and 808. The wireless communication devices 812-1 through 812-5 are generally referred to herein collectively as wireless communication devices 812 and individually as wireless communication device 812. In the following description, the wireless communication devices 812 are oftentimes UEs, but the present disclosure is not limited thereto.

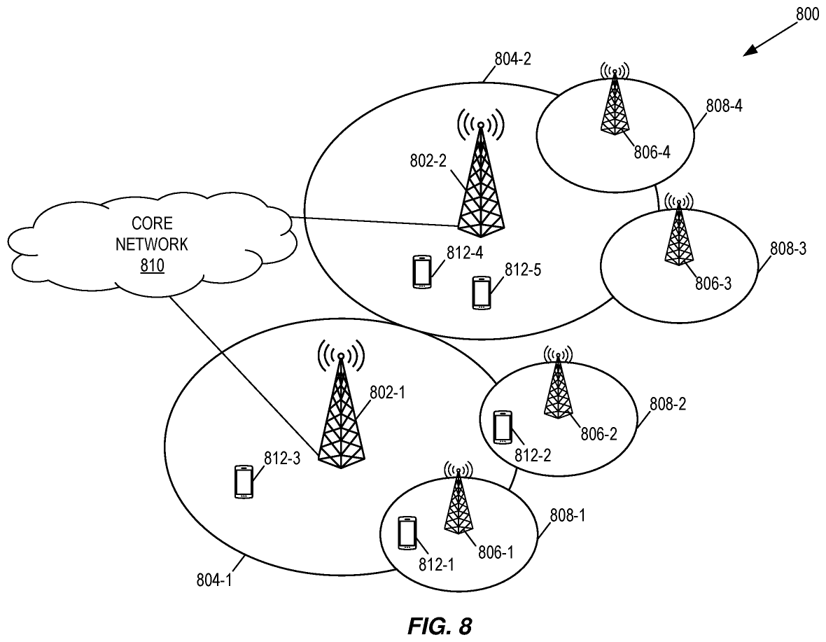

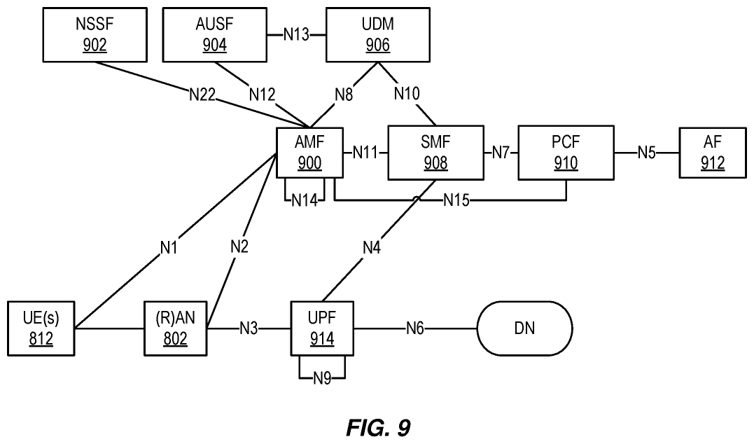

FIG. 9 illustrates a wireless communication system represented as a 5G network architecture composed of core Network Functions (NFs), where interaction between any two NFs is represented by a point-to-point reference point/interface. FIG. 9 can be viewed as one particular implementation of the system 800 of FIG. 8.

Seen from the access side the 5G network architecture shown in FIG. 9 comprises a plurality of UEs 812 connected to either a RAN 802 or an Access Network (AN) as well as an AMF 900. Typically, the R(AN) 802 comprises base stations, e.g., such as eNBs or gNBs or similar. Seen from the core network side, the 5GC NFs shown in FIG. 9 include a NSSF 902, an AUSF 904, a UDM 906, the AMF 900, a SMF 908, a PCF 910, and an Application Function (AF) 912. The core network nodes described here, such as PCF 910, AMF 900, UDM 906, and AF 912 are similar to and perform the same functionality as the core network nodes described above with reference to FIGS. 5-7, such as the PCF 108, AMF 106, UDM 110, and AF 116, respectively.

Reference point representations of the 5G network architecture are used to develop detailed call flows in the normative standardization. The N1 reference point is defined to carry signaling between the UE 812 and AMF 900. The reference points for connecting between the AN 802 and AMF 900 and between the AN 802 and UPF 914 are defined as N2 and N3, respectively. There is a reference point, N11, between the AMF 900 and SMF 908, which implies that the SMF 908 is at least partly controlled by the AMF 900. N4 is used by the SMF 908 and UPF 914 so that the UPF 914 can be set using the control signal generated by the SMF 908, and the UPF 914 can report its state to the SMF 908. N9 is the reference point for the connection between different UPFs 914, and N14 is the reference point connecting between different AMFs 900, respectively. N15 and N7 are defined since the PCF 910 applies policy to the AMF 900 and SMF 908, respectively. N12 is required for the AMF 900 to perform authentication of the UE 812. N8 and N10 are defined because the subscription data of the UE 812 is required for the AMF 900 and SMF 908.

The 5GC network aims at separating UP and CP. The UP carries user traffic while the CP carries signaling in the network. In FIG. 9, the UPF 914 is in the UP and all other NFs, i.e., the AMF 900, SMF 908, PCF 910, AF 912, NSSF 902, AUSF 904, and UDM 906, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 900 and SMF 908 are independent functions in the CP. Separated AMF 900 and SMF 908 allow independent evolution and scaling. Other CP functions like the PCF 910 and AUSF 904 can be separated as shown in FIG. 9. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

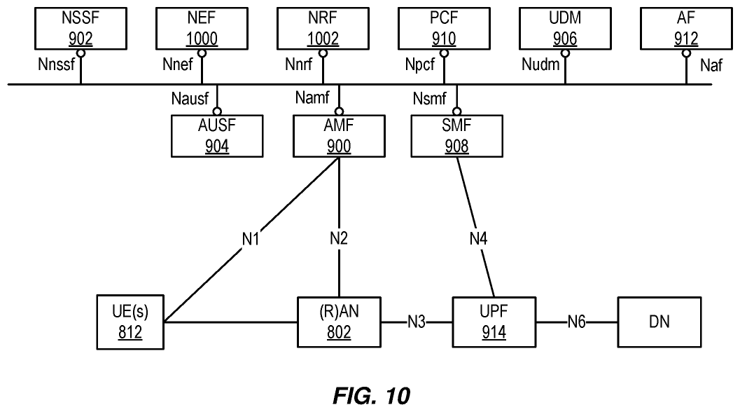

FIG. 10 illustrates a 5G network architecture using service-based interfaces between the NFs in the CP, instead of the point-to-point reference points/interfaces used in the 5G network architecture of FIG. 9. However, the NFs described above with reference to FIG. 9 correspond to the NFs shown in FIG. 10. The service(s) etc. that a NF provides to other authorized NFs can be exposed to the authorized NFs through the service-based interface. In FIG. 10 the service based interfaces are indicated by the letter “N” followed by the name of the NF, e.g., Namf for the service based interface of the AMF 900 and Nsmf for the service based interface of the SMF 908, etc. The NEF 1000 and the NRF 1002 in FIG. 10 are not shown in FIG. 9 discussed above. However, it should be clarified that all NFs depicted in FIG. 9 can interact with the NEF 1000 and the NRF 1002 of FIG. 10 as necessary, though not explicitly indicated in FIG. 9.

Some properties of the NFs shown in FIGS. 9 and 10 may be described in the following manner. The AMF 900 provides UE-based authentication, authorization, mobility management, etc. A UE 812 even using multiple access technologies is basically connected to a single AMF 900 because the AMF 900 is independent of the access technologies. The SMF 908 is responsible for session management and allocates Internet Protocol (IP) addresses to UEs. It also selects and controls the UPF 914 for data transfer. If a UE 812 has multiple sessions, different SMFs 908 may be allocated to each session to manage them individually and possibly provide different functionalities per session. The AF 912 provides information on the packet flow to the PCF 910 responsible for policy control in order to support QoS. Based on the information, the PCF 910 determines policies about mobility and session management to make the AMF 900 and SMF 908 operate properly. The AUSF 904 supports authentication function for UEs or similar and thus stores data for authentication of UEs or similar while the UDM 906 stores subscription data of the UE 812. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

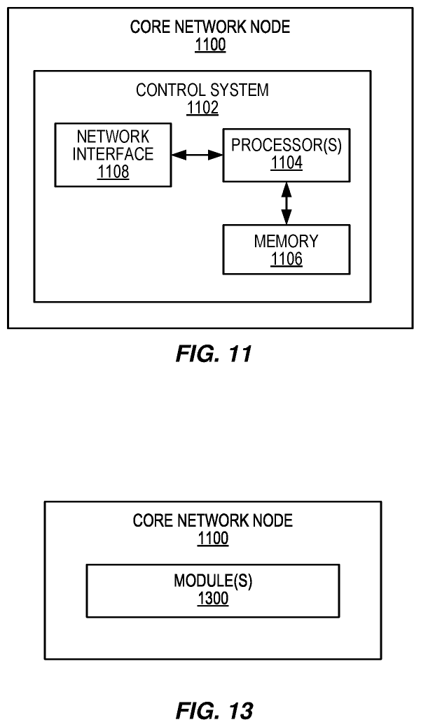

FIG. 11 is a schematic block diagram of a core network node 1100 according to some embodiments of the present disclosure. Optional features are represented by dashed boxes. As illustrated, the core network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry.

The one or more processors 1104 operate to provide one or more functions of a core network node 1100 as described herein. In some embodiments, the function(s) are implemented in software that is stored, e.g., in the memory 1106 and executed by the one or more processors 1104. In an embodiment, the core network node 1100 can perform the functionality as described herein with regard to the PCF 108, AMF 106, UDM 110, UDF 112, NEF 114, or AF 116.

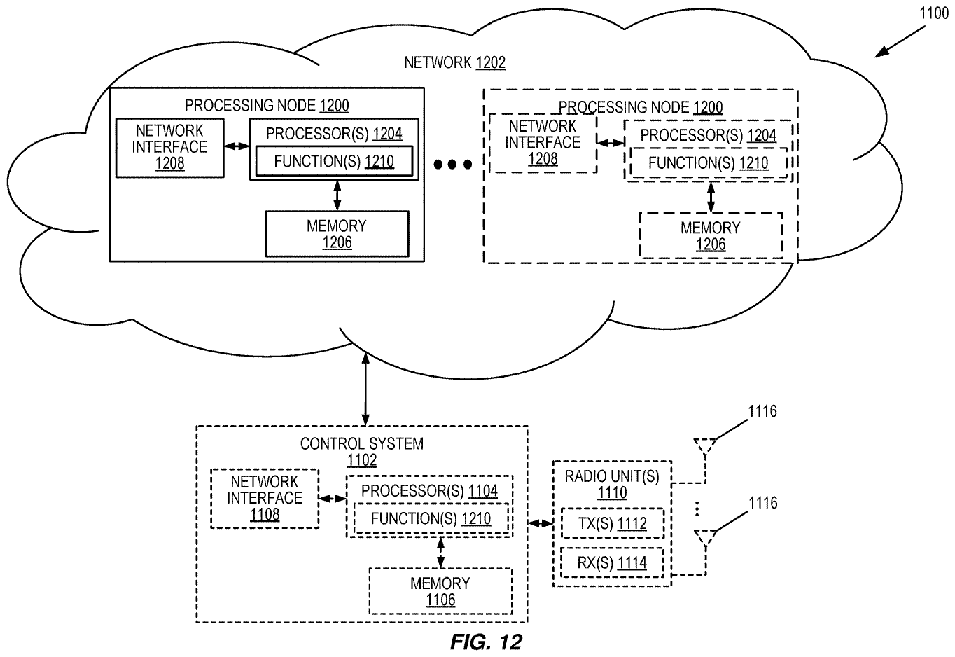

FIG. 12 is a schematic block diagram that illustrates a virtualized embodiment of the core network node 1100 according to some embodiments of the present disclosure. This discussion is equally applicable to other types of network nodes. Further, other types of network nodes may have similar virtualized architectures. Again, optional features are represented by dashed boxes.

As used herein, a “virtualized” core network node is an implementation of the core network node 1100 in which at least a portion of the functionality of the core network node 1100 is implemented as a virtual component(s) (e.g., via a virtual machine(s) executing on a physical processing node(s) in a network(s)). As illustrated, in this example, the core network node 1100 may include the control system 1102 and/or the one or more radio units 1110, as described above. The control system 1102 may be connected to the radio unit(s) 1110 via, for example, an optical cable or the like. The core network node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICS, FPGAs, and/or the like), memory 1206, and a network interface 1208.

In this example, functions 1210 of the core network node 1100 described herein are implemented at the one or more processing nodes 1200 or distributed across the one or more processing nodes 1200 and the control system 1102 and/or the radio unit(s) 1110 in any desired manner. In some particular embodiments, some or all of the functions 1210 of the core network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of core network node 1100 or a node (e.g., a processing node 1200) implementing one or more of the functions 1210 of the core network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the core network node 1100 according to some other embodiments of the present disclosure. The core network node 1100 includes one or more modules 1300, each of which is implemented in software. The module(s) 1300 provide the functionality of the core network node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

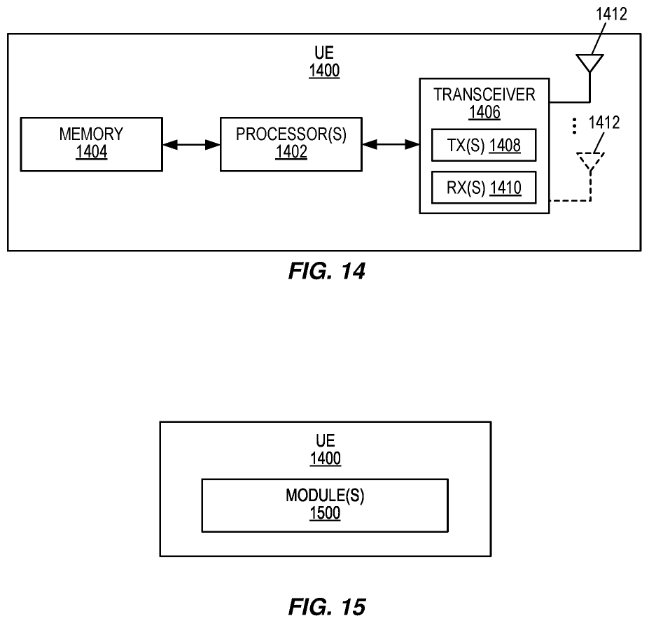

FIG. 14 is a schematic block diagram of a wireless communication device 1400 according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a core network node for obtaining consent from a subscriber about configuring a new User Equipment (UE), Route Selection Policy (USRP), rule, the method comprising:
determining that subscriber consent is required before configuring the new URSP rule for a UE associated with the subscriber;
providing an indication of the new URSP rule to the subscriber; and
in response to receiving an acceptance indication, provisioning the UE with the new URSP rule.

2. The method of claim 1, wherein the subscriber is an enterprise account, and providing the indication of the new URSP rule to the subscriber comprises providing the indication of the new URSP rule to a server associated with the enterprise account.

3. The method of claim 1, further comprising:
providing a notification to the UE on which the new URSP rule is provisioned.

4. The method of claim 3, wherein the providing the notification is based on location information associated with at least one of a subscriber account or the UE associated with the subscriber.

5. The method of claim 1, wherein the providing the indication of the new URSP rule to the subscriber comprises providing the indication to the UE associated with the subscriber.

6. The method of claim 1, wherein the providing the indication of the new URSP rule to the subscriber comprises providing the indication to another UE associated with the subscriber.

7. The method of claim 1, further comprising:
setting a flag in subscription data associated with the subscriber that identifies the acceptance indication.

8. The method of claim 1, wherein the determining that subscriber consent is required comprises:
providing the new URSP rule and subscriber information to a Unified Data Management (UDM) function; and
receiving an indication of subscriber consent requirement from the UDM function.

9. The method of claim 8, wherein the indication of subscriber consent requirement further comprises a callback Uniform Resource Locator (URL).

10. The method of claim 9, wherein the providing the indication of the new URSP rule to the subscriber comprises providing the callback URL to the subscriber.

11. The method of claim 1, wherein in response to receiving a declination indication:
setting a flag in subscription data associated with the subscriber that identifies the declination indication.

12. The method of claim 1, wherein the core network node a Policy Control Function.

13. A core network node configured for obtaining consent from a subscriber about configuring a new User Equipment (UE) Route Selection Policy (USRP) rule, the core network node comprising processing circuitry configured to:
determine that subscriber consent is required before provisioning the new URSP rule for a UE associated with the subscriber;
provide an indication of the new URSP rule to the subscriber; and
in response to receiving an indication of consent, provision the UE with the new URSP rule.

14. The core network node of claim 13, wherein the subscriber is an enterprise account, and providing the indication of the new URSP rule to a server associated with the enterprise account.

15. The core network node of claim 14, wherein the processing circuitry is further configured to:
providing a notification to the UE on which the new URSP rule is provisioned.

16-23. (canceled)

24. A method performed by a User Equipment (UE) for responding to a request for consent about configuring a new UE Route Selection Policy (USRP) rule, the method comprising:
receiving, from a core network node, an indication of a new URSP rule, wherein the indication of the new URSP rule comprises information about at least one of: charging and quality of service characteristics of the new URSP rule; and
displaying the indication of the new URSP rule on the UE.

25. The method of claim 24, further comprising:
providing at least one of an acceptance of the new URSP rule or a declination of the new URSP rule to a core network node.

26. The method of claim 24, further comprising:
providing at least one of an acceptance of the new URSP rule or a declination of the new URSP rule via a callback Uniform Resource Locator (URL) that was associated with the indication of the new URSP rule.

27. The method of claim 24, wherein the core network node is a Policy Control Function (PCE).

28. A User Equipment (UE) configured for responding to a request for consent about configuring a new UE Route Selection Policy (USRP) rule, the UE comprising a radio and processing circuitry configured to:
receive from a core network node an indication of a new URSP rule, wherein the indication of the new URSP rule comprises information about charging and quality of service characteristics of the new URSP rule; and
display the indication of the new URSP rule on the UE.

29-31. (canceled)
